(19) United States
(12) Patent Application Publication
(10) Pub. No.: US 2013/0305355 A1
(43) Pub. Date: Nov. 14, 2013

(54) DATA SECRECY METHOD AND ELECTRONIC DEVICE USING DATA SECRECY METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: YIN-ZHAN WANG, Shenzhen (CN); JUN-WEI ZHANG, Shenzhen (CN); JUN ZHANG, Shenzhen (CN); TSUNG-JEN CHUANG, New Taipei (TW)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/872,176

(22) Filed: Apr. 29, 2013

(30) Foreign Application Priority Data
May 9, 2012 (CN) 2012101416227

(51) Int. Cl. G06F 21/31; G06F 21/32

(52) U.S. Cl. CPC G06F 21/31; G06F 21/32
USPC 726/19

(57) ABSTRACT

A data secrecy system of an electronic device detects whether a screen unlocking interface of the electronic device is activated. The data secrecy system controls the recorder to record a phrase said by a user after the user is invited to speak. And then the data secrecy system extracts characteristics of the recorded phrase. The data secrecy system determines a privilege level for the user to access all or a part of functions of the electronic device according to the characteristics of the phrase, and controls the electronic device to work according to the determined privilege level of the user.

### BACKGROUND

1. Technical Field

The present disclosure relates to data security technologies, and more particularly, to a data secrecy method and an electronic device using the data secrecy method.

2. Description of Related Art

Electronic devices, such as smart phones, mobile internet devices, digital cameras, or portable computers, store private data. In some particular situations, such as when the electronic device is used by the families or friends of an owner of the electronic device, the private data may be discovered, which may cause unexpected problems to the owner. Therefore, there is room for improvement in the art.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram of an exemplary embodiment of an electronic device including a data secrecy system having a phrase processing module and an access authentication module.

FIG. 2 is a schematic block diagram of the phrase processing module of FIG. 1.

FIG. 3 is a schematic block diagram of the access authentication module of FIG. 1.

FIG. 4 is a schematic block diagram of another exemplary embodiment of the electronic device.

FIG. 5 is a flowchart of one embodiment of a data secrecy method implemented by the electronic device of FIG. 1.

FIG. 6 is a flowchart of another embodiment of a data secrecy method implemented by the electronic device of FIG. 4.

### DETAILED DESCRIPTION

Reference will be made to the drawings to describe various embodiments.

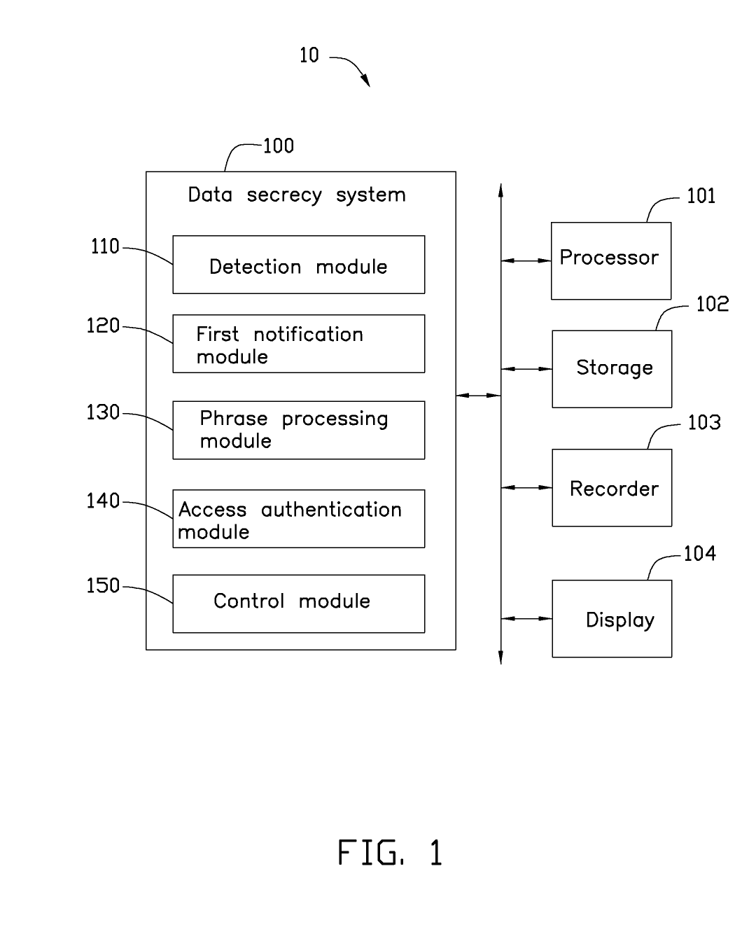

FIG. 1 is a schematic block diagram of an exemplary embodiment of an electronic device 10 including a data secrecy system 100. The electronic device 10 further includes a processor 101, a storage 102, a recorder 103, and a display 104. In one embodiment, the electronic device 10 may be, for example, a smart phone, a mobile internet device, or other similar device. FIG. 1 is one example of the electronic device 10, and the electronic device 10 can include more or fewer components than those shown in the embodiment, or have a different configuration of the components.

The data secrecy system 100 may include a plurality of programs in the form of one or more computerized instructions stored in the storage 102 and executed by the processor 101 to perform operations of the electronic device 10. In the embodiment, the data secrecy system 100 includes a detection module 110, a first notification module 120, a phrase processing module 130, an access authentication module 140, and a control module 150. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

After the display 104 of the electronic device 10 locks (e.g., the electronic device 10 cannot receive external input through the display 104), the detection module 110 detects, in real-time, whether a screen unlocking interface of the electronic device 10 is activated by a user. In one embodiment, the screen unlocking interface is a particular graphic user interface (GUI) of the electronic device 10, which is used to unlock the display 104.

The first notification module 120 notifies the user to input phrase to unlock the display 104, when the screen unlocking interface is activated. In the embodiment, the first notification module 120 may display notification information on the display 104 to notify the user to input phrase corresponding to the displayed information. The notification information may be a text message, a picture, or a recorded vocal sound. In one embodiment, the notification information is a text message, such as “Please say the password”.

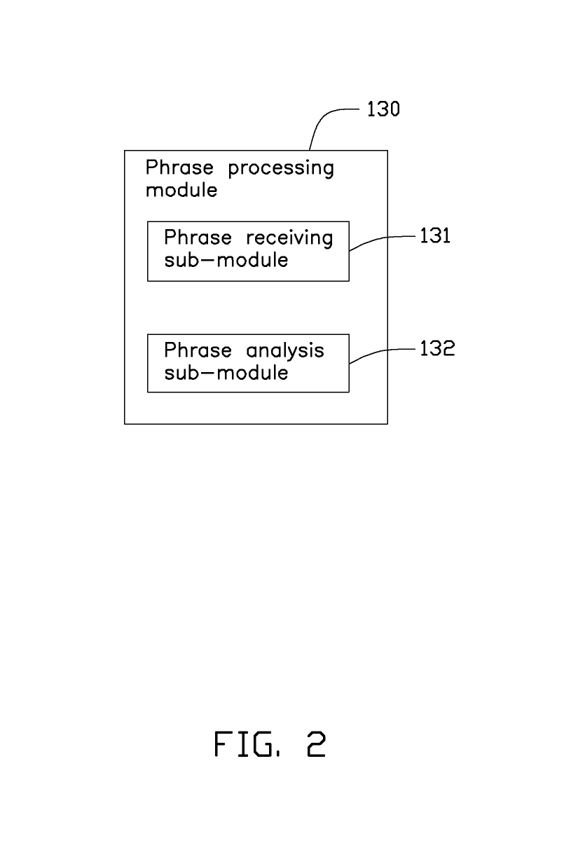

The phrase processing module 130 controls the recorder 103 to record the phrase input by the user, and analyzes the recorded phrase to extract characteristics of the recorded phrase. FIG. 2 is a schematic block diagram of the phrase processing module 130 of FIG. 1. The phrase processing module 130 includes a phrase receiving sub-module 131 and a phrase analysis sub-module 132. The phrase receiving sub-module 131 obtains the recorded phrase from the recorder 103. The phrase analysis sub-module 132 extracts the characteristics of the obtained phrase using speech recognition technologies. In the embodiment, the characteristics may include, for example a vocal frequency, a waveform, and actual words in the phrase.

The access authentication module 140 determines a privilege level for the user to access all or some functions of the electronic device 10 according to the characteristics of the recorded phrase. In the embodiment, the electronic device 10 may provide different privilege levels to access different functions of the electronic device 10 according to different characteristics. For example, a full access level may be provided for accessing all functions of the electronic device 10. A partial access level may be provided for accessing some of predetermined functions (e.g., game applications, and phone and web functions) of the electronic device 10.

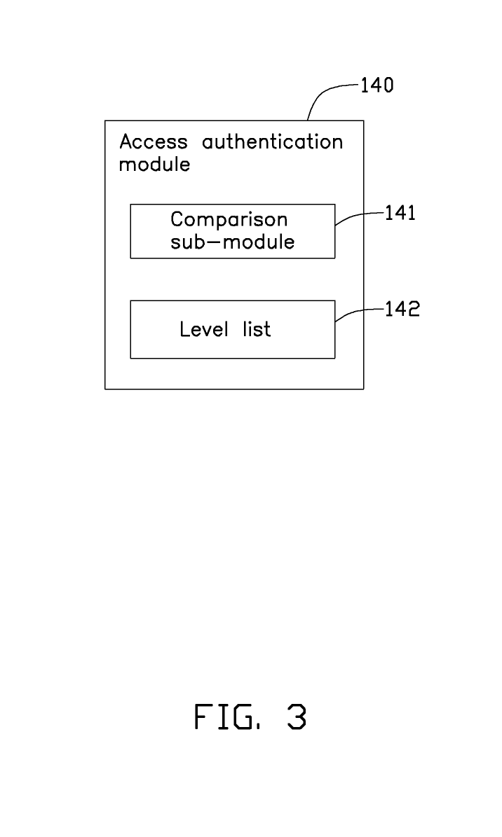

FIG. 3 is a schematic block diagram of the access authentication module 140. The access authentication module 140 includes a comparison sub-module 141 and a level list 142. The level list 142 includes reference characteristics, and a plurality of privilege levels corresponding to different reference characteristics. Each reference characteristic includes a keyword at least. The comparison sub-module 141 compares the characteristics extracted from the recorded phrase with each of the reference characteristics, and then determines a privilege level corresponding to the reference characteristics. If the user is the owner of the electronic device 10, the user may have a full access level for accessing all of the functions of the electronic device 10; if the user is not the owner, the user may only have the partial access level corresponding to the reference characteristics for accessing only some of predetermined functions of the electronic device 10.

Table 1 shows a relationship between the privilege levels and reference characteristics. When a frequency of the recorded phrase matches a predetermined standard frequency, and the characteristics of the recorded phrase include a first keyword (e.g., “owner”), the full access level may be determined for the user and the user can access to all functions (i.e., all resources and applications) of the electronic device 10. When the frequency of the recorded phrase does not match the standard frequency, but the characteristics of the recorded phrase include a second keyword (e.g., “friend”), the user may have access to a game level for access to only games of the electronic device 10. When the frequency of the recorded phrase does not match the standard frequency, but the characteristics of the recorded phrase include a third keyword (e.g., “family”), the user may have an access to only use a phone call function and a message function of the electronic device 10. And when the frequency of the recorded phrase does not match the standard frequency, but the characteristics of the recorded phrase include a fourth keyword (e.g., colleague), the user may have an access for only accessing to an “Internet” function of the electronic device 10.

TABLE 1

Reference characteristics

| Access Levels | Frequency | Keyword |
|---|---|---|
| Full access level | Match | First keyword |
| Game access level | — | Second keyword |
| Phone access level | — | Third keyword |
| Internet access level | — | Fourth keyword |

The control module 150 controls the electronic device 10 to work according to the determined privilege level of the user, such as releasing all or a part of predetermined functions to be accessed by the user according to the privilege level of the user. In the embodiment, if the privilege level of the user is the full access level, all of functions of the electronic device 10 can be accessed by the user; if the privilege level of the user the partial access level, only a part of predetermined functions (e.g. phone function, web function) of the electronic device 10 can be accessed by the user.

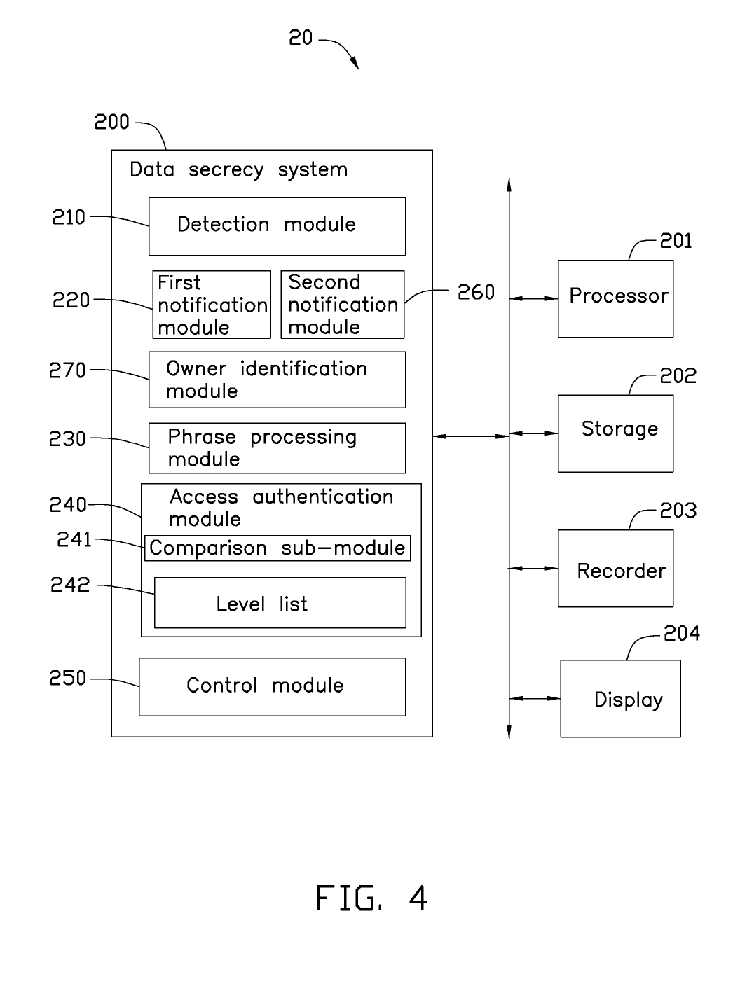

FIG. 4 is a schematic block diagram of another exemplary embodiment of an electronic device 20 including a data secrecy system 200. The data secrecy system 200 is similar to the data secrecy system 100, except that the data secrecy system 200 further includes a second notification module 260 and an owner identification module 270.

The first notification module 220 notifies the user to say a first phrase to unlock the display 204, when the display 204 unlocking interface is activated. In the embodiment, the first notification module 220 may display first notification information on the display 204 to notify the user to speak corresponding to the displayed information. The first notification information may be a text message, a picture, or a recorded vocal sound. In one embodiment, the notification information is a text message, such as “Please say ‘Hello.’”

The phrase processing module 230 controls the recorder 203 to record the first phrase inputted by the user, and analyzes the first phrase to extract a voice frequency of the first phrase.

The owner identification module 270 identifies whether the user is the owner of the electronic device 20 according to the voice frequency of the first phrase. In the embodiment, the owner identification module 270 may compare the voice frequency of the first phrase with a reference frequency of the owner stored in the storage 202. When the voice frequency of the first phrase matches the reference frequency, the user is identified to be the owner; when the voice frequency of the first phrase does not match the reference frequency of the owner, the user is determined not to be the owner.

The second notification module 260 notifies the user to input a second phrase. The second notification module 260 displays a second notification information to notify the user to say a second thing, and the second notification information may be a text message, a picture, or a recorded vocal sound as well as the first notification information. In one embodiment, the second notification information is a text, such as “Please say the password.”

The phrase processing module 230 extracts one or more spoken words from the second phrase. The phrase processing module 230 may extract the one or more spoken words by analyzing the second phrase using known speech recognition (SR) technologies.

The access authentication module 240 determines a privilege level for the user to access all or a part of functions of the electronic device 20 according to the spoken words extracted from the second phrase. In the embodiment, the electronic device 20 may provide different privilege levels to access different functions of the electronic device 20 according to different characteristics. For example, a full access level may be provided for accessing all functions of the electronic device 20. A partial access level may be provided for accessing a part of predetermined functions (e.g., game applications, and phone and web functions) of the electronic device 20.

The access authentication module 240 searches a table 2 as shown below to determine the privilege level for the user according to the spoken words of the second phrase, when the user is the owner. Table 2 shows a relationship between the privilege levels and a plurality of keywords. When the spoken words of the second phrase include a first keyword (e.g. “owner”), the full access level may be determined for the user and the user can access to all functions (i.e., all resources and applications) of the electronic device 20. When the spoken words of the second phrase include a second keyword (e.g., “friend”), the user may have an access to a game level for access to only games of the electronic device 20. When the spoken words of the second phrase include a third keyword (e.g., “family”), the user may have an access to only use a phone call function and a message function of the electronic device 20. And when the spoken words of the second phrase include a fourth keyword (e.g., “colleague”), the user may have an access for only accessing to an “Internet” function of the electronic device 20.

TABLE 2

| Access levels | Keyword |
|---|---|
| Full access | First keyword |
| Game access level | Second keyword |
| Phone access level | Third keyword |
| Internet access level | Fourth keyword |

The access authentication module 240 searches a table 3 as shown below to determine the privilege level for the user according to the spoken words of the second phrase, when the user is not the owner. Table 3 shows a relationship between the privilege levels and a plurality of keywords. When the spoken words of the second phrase include a second keyword (e.g., “friend”), the user may have an access to a game level for access to only games of the electronic device 20. When the spoken words of the second phrase include a third keyword (e.g., “family”), the user may have an access to only use a phone call function and a message function of the electronic device 20. And when the spoken words of the second phrase include a fourth keyword (e.g., “colleague”), the user may have an access for only accessing to an “Internet” function of the electronic device 20.

TABLE 3

| Access levels | Keyword |
|---|---|
| Game access level | Second keyword |
| Phone access level | Third keyword |
| Internet access level | Fourth keyword |

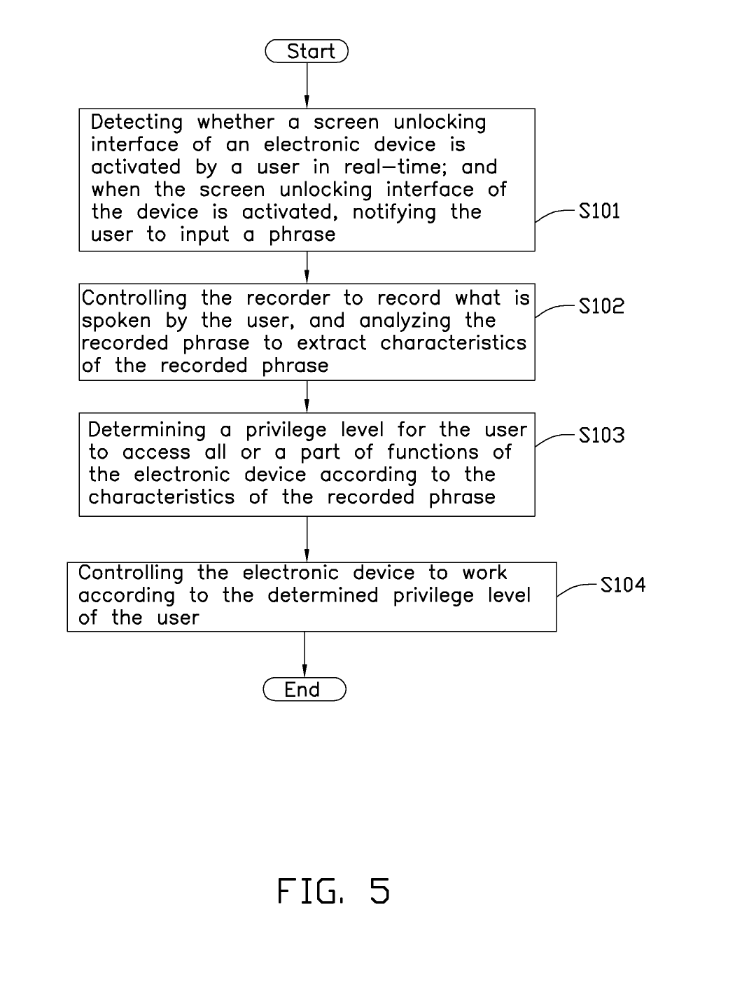

FIG. 5 is a flowchart of one embodiment of a data secrecy method implemented by the electronic device 10 of FIG. 1. The method includes the following steps, but it should be understood that in other embodiments, additional steps may be added, others deleted, and the ordering of the steps may be changed.

In step S101, after the display 104 of the electronic device 10 has been locked, the detection module 110 detects whether a screen unlocking interface of the electronic device 10 is activated by a user in real-time. And when the screen unlocking interface of the device 10 is activated, the first notification module 120 notifies the user to input a phrase.

In step S102, the phrase processing module 130 controls the recorder 103 to record what is spoken by the user, and analyzes the recorded phrase to extract characteristics of the recorded phrase.

In step S103, the access authentication module 140 determines a privilege level for the user to access all or a part of functions of the electronic device 10 according to the characteristics of the recorded phrase.

In step S104, the control module 150 controls the electronic device 10 to work according to the determined privilege level of the user. In the embodiment, if the privilege level of the user is the full access level, all of functions of the electronic device 10 can be accessed by the user; if the privilege level of the user the partial access level, only a part of predetermined functions (e.g. phone function, web function) of the electronic device 10 can be accessed by the user.

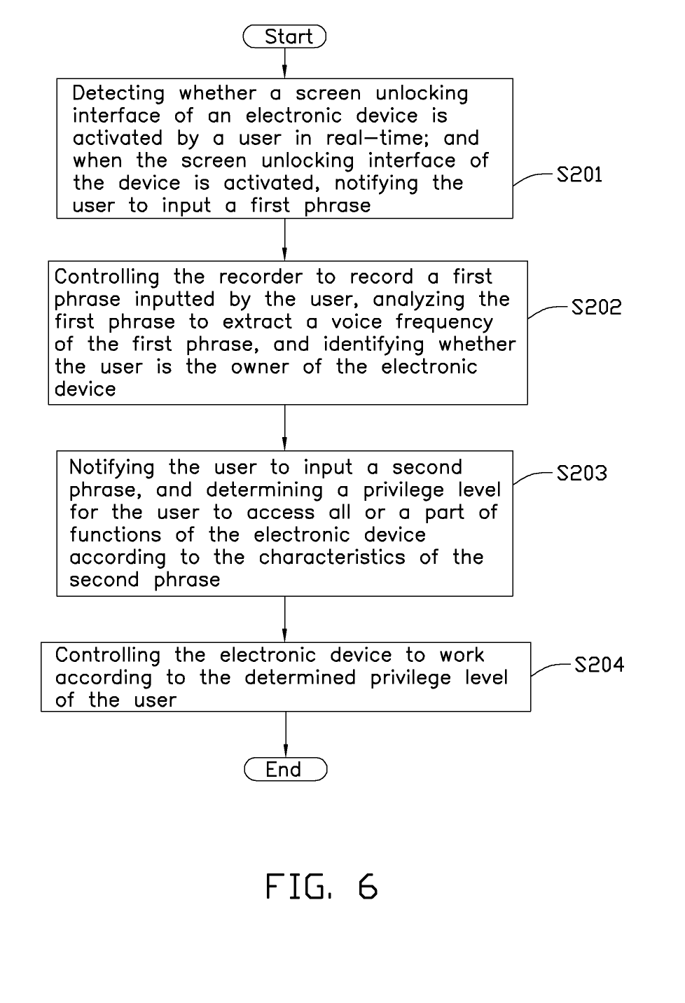

FIG. 6 is a flowchart of one embodiment of a data secrecy method implemented by the electronic device 20 of FIG. 4. The method includes the following steps, but it should be understood that in other embodiments, additional steps may be added, others deleted, and the ordering of the steps may be changed.

In step S201, after the display 104 of the electronic device 20 has been locked, the detection module 210 detects whether a screen unlocking interface of the electronic device 20 is activated by a user in real-time. When the screen unlocking interface is activated, the first notification module 220 notifies the user to input a first phrase to unlock the display 204.

In step S202, the phrase processing module 230 controls the recorder 203 to record a first phrase inputted by the user, and analyzes the first phrase to extract a voice frequency of the first phrase, and then the owner identification module 270 identifies whether the user is the owner of the electronic device 20. The owner identification module 270 compares the voice frequency of the first phrase with a reference frequency of the owner stored in the storage 202. When the voice frequency of the first phrase matches the reference frequency of the owner, the user is identified to be the owner, otherwise, the user is determined not to be the owner.

In step S203, the second notification module 260 notifies the user to input a second phrase, and then the access authentication module 240 determines a privilege level for the user to access all or a part of functions of the electronic device 20 according to the spoken words of the second phrase. The access authentication module 240 searches the table 2 to provide privilege levels according to the spoken words of the second phrase, when the user is the owner. The access authentication module 240 searches the table 3 to provide privilege levels according to the spoken words of the second phrase, when the user is not the owner.

In step S204, the control module 250 controls the electronic device 20 to work according to the determined privilege level of the user. In the embodiment, if the privilege level of the user is the full access level, all of functions of the electronic device 20 can be accessed by the user; if the privilege level of the user the partial access level, only some predetermined functions (e.g. phone function, web function) of the electronic device 20 can be accessed by the user.

In summary, the data secrecy system allows different levels of functionality to be accessed on the electronic device, depending on particular biometric considerations. Thus, the security of the privacy is improved.

It is to be understood that even though numerous characteristics and advantages of the present embodiments have been set forth in the foregoing description, with details of the structures and functions of the embodiments, the disclosure is illustrative only; and changes may be made in detail, especially in the matters of arrangement of parts within the principles of the embodiments to the full extent indicated by the broad general meaning of the terms in which the appended claims are expressed.

What is claimed is:

1. An electronic device, comprising:
a processor;
a recorder;
a display;
a storage; and
one or more programs stored in the storage and executed by the processor, the one or more programs comprising:
a detection module detecting whether a screen unlocking interface of the electronic device is activated;
a phrase processing module controlling the recorder to record a phrase inputted by a user when the screen unlocking interface is activated, and analyzing the recorded phrase to extract characteristics of the recorded phrase;
an access authentication module determining a privilege level for the user to access functions of the electronic device according to the characteristics of the recorded phrase; and
a control module controlling the electronic device to work according to the determined privilege level of the user.

2. The electronic device of claim 1, wherein the one or more programs further comprises a notification module that notifies the user to input the phrase when the screen unlocking interface is activated.

3. The electronic device of claim 1, wherein the phrase processing module extracts the characteristics of the phrase using speech recognition technologies.

4. The electronic device of claim 1, wherein the characteristics comprises a vocal frequency and spoken words of the phrase.

5. The electronic device of claim 1, wherein the access authentication module comprises a level list storing reference characteristics and a plurality of privilege levels corresponding to different reference characteristics.

6. The electronic device of claim 5, wherein the access authentication module further comprises a comparison module to compare the characteristics extracted from the recorded phrase with each of the reference characteristics to determine the privilege level of the user corresponding to the reference characteristics.

7. The electronic device of claim 5, wherein the control module controls the electronic device to work by releasing all or a part of predetermined functions to be accessed by the user according to the privilege level of the user.

8. The electronic device of claim 4, wherein the one or more programs further comprises an owner identification module to identify whether the user is an owner of the electronic device by comparing the vocal frequency of the recorded phrase with a predetermined standard frequency of the owner.

9. The electronic device of claim 8, wherein the access authentication module determines the privilege level for the user according to the spoken words of a second phrase input by the user.

10. The electronic device of claim 9, wherein the user has a first privilege level for access all of functions of the electronic device when the spoken words of the recorded phrase include a first predetermined keyword, and the user has a second privilege level for accessing only a part of predetermined functions of the electronic device when the spoken words of the recorded phrase include a second predetermined keyword.

11. A data secrecy method of an electronic device having a recorder, the method comprising:
detecting whether a screen unlocking interface of the electronic device is activated;
controlling the recorder to record a phrase inputted by a user when the screen unlocking interface is activated, and analyzing the recorded phrase to extract characteristics of the recorded phrase;
determining a privilege level for the user to access functions of the electronic device according to the characteristics of the recorded phrase; and
controlling the electronic device to work according to the determined privilege level of the user.

12. The method of claim 11, wherein the method further comprising:
notifying the user to input the phrase when the screen unlocking interface is activated.

13. The method of claim 11, wherein the controlling step comprises:
extracting the characteristics of the phrase using speech recognition technologies

14. The method of claim 11, wherein the characteristics comprises a vocal frequency of and spoken words of the phrase.

15. The method of claim 14, wherein the electronic device comprises a level list storing reference characteristics and a plurality of privilege levels corresponding to different reference characteristics.

16. The method of claim 15, wherein the determining step comprises:
comparing the characteristics extracted from the recorded phrase with each of the reference characteristics and determining the privilege level of the user corresponding to the reference characteristics.

17. The method of claim 16, wherein the controlling step comprises:
releasing all or a part of predetermined functions to be accessed by the user according to the privilege level of the user.

18. The method of claim 14, wherein the method further comprises:
identifying whether the user is an owner of the electronic device by comparing the vocal frequency of the recorded phrase with a predetermined reference frequency of the owner of the electronic device.

19. The method of claim 18, wherein the determining step comprises:
determining the privilege level for the user according to the spoken words of a second phrase input by the user.

20. The method of claim 19, wherein the user has a first privilege level for access all of functions of the electronic device when the spoken words of the recorded phrase include a first predetermined keyword, and the user has a second privilege level for accessing only a part of predetermined functions of the electronic device when the spoken words of the recorded phrase include a second predetermined keyword.
